(19) United States
(12) Patent Application Publication
(10) Pub. No.: US 2003/0090595 A1
(43) Pub. Date: May 15, 2003

(54) Device for displaying a video signal by means of a scanning system

(76) Inventors: Philippe Vilard, Houilles (FR); Marnik Bogaert, Brugge (BE)

Correspondence Address: U.S. Philips Corporation, 580 White Plains Road, Tarrytown, NY, 10591, US

(21) Appl. No.: 10/281,695

(22) Filed: Oct. 28, 2002

(30) Foreign Application Priority Data
Oct. 30, 2001 (FR) 0114049

(51) Int. Cl. H04N 5/21

(52) U.S. Cl. 348/626

(57) ABSTRACT

The invention relates to a device for displaying a video signal on a screen by means of a scanning operation, said video signal being characterized by an assembly of parameters, said display device comprising a derivative circuit for generating a derivative signal from said video signal, a threshold circuit for performing a threshold operation at a given threshold on said derivative signal so as to generate a modified derivative signal, a modulation circuit for modulating the scanning velocity on the basis of said modified derivative signal.

The invention allows improvement of the impression of contrast of transitions of a small amplitude without accentuating the noise signal contained in the video signal. To this end, the display device is characterized in that it comprises additional means for varying the value of said threshold as a function of said parameters.

### FIELD OF THE INVENTION

The invention relates to a device for displaying a video signal on a screen by means of a scanning operation, said video signal being characterized by an assembly of parameters, said display device comprising:

a derivative circuit for generating a derivative signal from said video signal,

a threshold circuit for performing a threshold operation at a given threshold on said derivative signal so as to generate a modified derivative signal,

a modulation circuit for modulating the scanning velocity on the basis of said modified derivative signal.

The invention finds numerous applications in devices displaying video signals on the screen of a cathode ray tube.

### BACKGROUND OF THE INVENTION

To improve the efficiency of the contents of a video signal, it is particularly interesting to accentuate the impression of contrast in the image, i.e. to visually accentuate the parts of the video signal corresponding to the transitions.

Transitions are understood to mean a parameter reflecting the frequency of the transition (i.e. in the frequency domain) as well as the amplitude of the transition (in the image domain).

When the video signal is displayed on a cathode ray tube, the contrast may be accentuated with the aid of a circuit of the SCAVEM type (Scan Velocity Modulation) which modulates the scanning velocity of the electron beams on the cathode ray tube. The velocity modulation is effected as a function of a derivative signal obtained from the video signal to be displayed, which is applied to a modulation circuit comprising a coil which is situated in the cathode ray tube.

A real video signal is the addition of an information signal conveying the video contents, and of a noise signal, the noise signal resulting from thermal noise and/or a residual component of the subcarrier in the luminance signal. To prevent amplification of a possible noise signal contained in the video signal upon display, the SCAVEM action is suppressed by the transitions whose values are lower than a fixed threshold.

U.S. Pat. No. 5,587,745 describes a circuit of this type.

These means for accentuating the contrast of a video signal have a certain number of limitations.

The threshold above which the transitions are accentuated is fixed. To prevent the risk of accentuating transitions of small amplitudes generated by the noise contained in the different video signals to be displayed, the value of the threshold is relatively important. The value of this threshold is all the more important as the maximum amplitudes of the transitions generated by the noise in the different video signals to be displayed must be increased, these signals containing a priori more or less noise.

When these accentuation means are used for video signals having a low noise level, they will certainly lead to an accentuation of the contrast for the transitions of a large amplitude, but this accentuation is not optimal to the extent that the accentuation threshold is too high with respect to the noise level. In other words, transitions of a small amplitude conveying information of the video content—and not of the noise—are not accentuated.

On the other hand, the amplitude transitions which are higher than said threshold are accentuated in a progressive manner. The accentuation is weaker as the transitions have a value which is near said threshold and stronger as the transitions have a value which is higher than said threshold. This is a consequence of the a priori fixation of the value of said threshold which involves a moderate accentuation of the transitions in its neighborhood so as not to risk accentuation of transitions generated by the residual noise: the accentuation of the video signal thus principally concerns the transitions having a strong amplitude. The transitions having a weaker amplitude of a value which is higher than said threshold are thus accentuated only moderately, which becomes manifest by a lack of contrast in certain parts of the video signal.

### OBJECT AND SUMMARY OF THE INVENTION

It is an object of the invention to propose a device for displaying a video signal, allowing an improvement of the impression of contrast of transitions of a small amplitude without accentuating the noise signal contained in the video signal.

To this end, the display device is characterized in that it comprises additional means for varying the value of said threshold as a function of said parameters.

In this way, the value of the threshold above which the transitions are accentuated is automatically adjusted as a function of the value of said parameters. Particularly, the threshold value is adjusted as a function of the noise level of said video signal.

If the video signal comprises a high noise level, the threshold will have a considerable value. In contrast, if the video signal has a low noise level, the threshold will have a low value. The automatic adjustment of the threshold thus allows an optimal accentuation of the transitions, regardless of the noise level in the video signal.

If the threshold value is automatically adjusted at the maximum level of the transitions generated by the noise in the video signal, the accentuation of the transitions is optimal and there are only the noise-generated transitions which are not accentuated. In other words, only the transitions of the signal conveying the video content are accentuated.

In so far as the threshold above which the transitions may be amplified is known, it is possible to effect a strong accentuation of the contrast for transitions whose level is only a little bit higher than said threshold. The contrast is then accentuated at all the transitions of the signal conveying the video content, which leads to an image of better quality.

The threshold value may also be adjusted as a function of the type of video signal. In this way, with the a priori knowledge of the quality of the video signal as a function of its type, the accentuation of the transitions is optimized. Moreover, this solution is less costly because it only involves a detection of the video signal type.

Particularly, a signal of the red-green-blue type (RGB) contains a priori less noise than a signal of the PAL type, which in turn contains a priori less noise than a signal of the SECAM type. Thus, three threshold values are defined a priori in accordance with the type of video signal: a threshold of low value for the signal of the RGB type, a threshold of medium value for the signal of the PAL type and a threshold of a high value for the signal of the SECAM type.

The threshold value may also be adjusted as a function of the spectral power distribution of said video signal in so far as the spectral distribution allows identification of the frequency range corresponding to the contribution of the noise signal.

The invention is also characterized in that the additional means comprise:

means for analyzing and extracting said parameters from said video signal,

means for converting said parameters into a control signal for varying the value of said threshold.

The analysis means particularly allow measurement of the noise level contained in the video signal, detection of the signal type of said video signal (PAL-SECAMRGB-NTSC . . . ), or measurement of the spectral power distribution of said video signal. These analysis means of the signal-processor type allow a permanent update of the knowledge of the characteristic features of the video signal to be displayed, which is particularly interesting if the noise level of the video signal changes or if the video signal type changes. Via a conversion of the D/A type of said parameters into a control signal, the threshold value above which the transitions are accentuated is optimized permanently to the characteristic features of the video signal. The derivative signal of the luminance signal is modified by the threshold circuit, such that the transitions of a level below said threshold corresponding to the transitions generated by the noise—are set at zero so as not to be accentuated. The derivative signal thus modified is applied to the modulation circuit.

The invention is also characterized in that the threshold circuit is constituted by two circuits each comprising a transistor arranged in a voltage follower configuration and biased by said control signal.

The threshold circuit having a variable threshold controlled by the control signal is composed of two symmetrical circuits, one performing the threshold operation for the positive transitions and the other performing the threshold operation for the negative transitions. The regulation of the threshold value, by acting directly on the bias of the transistor via the level of the control signal, is simple and precise. Moreover, the structure of each circuit comprises a small number of components, which leads to a less costly solution.

The invention is also characterized in that the apparatus comprises a clipping circuit for clipping said modified derivative signal.

To prevent accentuation of the transitions of the video signal in an exaggerated manner and thus avoid a deformation of the video content, the amplitude of the derivative signal is limited after the threshold operation by clipping it at a fixed value.

The invention also relates to a television apparatus for improving the impression of contrast of a video signal, said television apparatus using the different characteristic means described hereinbefore.

The invention also relates to a display method whose steps correspond to the different functions performed by the means described hereinbefore.

### BRIEF DESCRIPTION OF THE DRAWINGS

These and other aspects of the invention are apparent from and will be elucidated, by way of non-limitative example, with reference to the embodiment(s) described hereinafter.

In the drawings:

FIG. 1 describes an embodiment of the invention,

FIG. 2 shows the variation of the level of accentuation of the transitions of the video signal as a function of the transition levels of said video signal,

FIGS. 3 and 4 show the variation of the threshold value as a function of the control signal levels,

FIGS. 5 and 6 show an example of the development of the control signals as a function of the value of the parameters characterizing the video signal to be displayed,

FIG. 7 shows the modification of a derivative signal according to the invention,

FIG. 8 shows a display apparatus for displaying the contents of a video signal on a screen.

### DESCRIPTION OF EMBODIMENTS

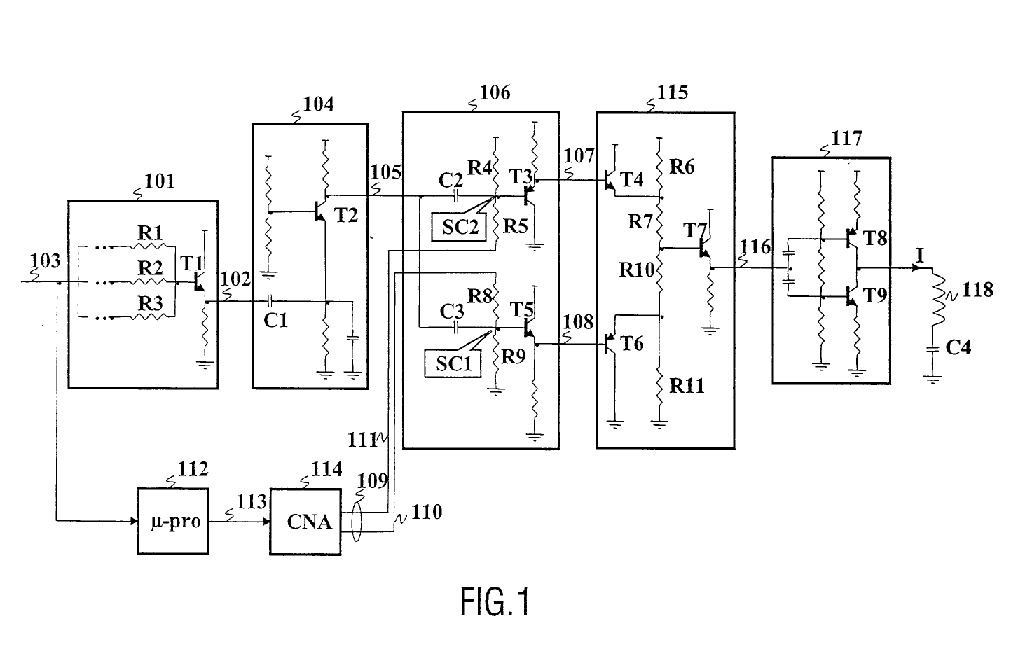

FIG. 1 describes an embodiment of the invention. This embodiment comprises a circuit 101 for matrixing the red-green-blue components, with which a luminance signal 102 based on the video signal 103 to be displayed on a cathode ray tube can be supplied. The luminance signal 102 is subsequently derived by a derivative circuit 104 supplying a derivative signal 105. The derivative signal 105 is then subjected to a threshold operation by the threshold circuit 106 having a variable threshold. The threshold circuit receives a double control signal 109 composed of a first control signal 110 for varying the threshold value for performing the threshold operation on the positive transitions, and a second control signal 111 for varying the threshold value for performing the threshold operation on the negative transitions. In parallel, computing means 112 supply characteristics 113 extracted from said video signal to conversion means 114 for converting them into said double control signal 109. The threshold circuit 106 supplies a double output signal 107-108, a first output signal 108 conveying the modified positive transitions, a second signal 107 conveying the modified negative transitions. This double output signal is subsequently clipped by the clipping circuit 115 for supplying a clipped derivative signal 116. The clipped derivative signal 116 is then amplified by the amplifier circuit 117 for supplying a current I having an amplitude which is proportional to said clipped signal 116 in the deflection coil 118 (arranged in series with a capacitance C4), these two elements allowing modulation of the scanning velocity of the cathode ray tube.

The video signal 103 is supposed to be a color signal composed of, for example, three color components R, G and B. However, it should be noted that the invention is also applicable in the case of a black and white video signal. Indeed, in this case, the luminance signal directly corresponds to the video signal.

The matrix circuit 101 is composed of three resistors R1-R2-R3 whose values allow the formation of a weighted sum of the color components R, G and B for supplying a luminance signal. The luminance signal is amplified by one unit gain by the transistor T1 so as to supply the luminance signal 102 at a low impedance.

The derivative circuit 104 is constituted by a capacitance C1 receiving said luminance signal 102 at one terminal and having its other terminal connected to the emitter of transistor T2. The transistor T2 is current-driven via the capacitance C1, by which an output signal 105 which is proportional to the derivative value of said luminance signal 102 can be supplied to its collector.

The threshold circuit 106 having a variable threshold is constituted by two symmetrical circuits, one for a threshold operation on the positive transitions, the other for a threshold operation on the negative transitions. The threshold value for performing the threshold operations on the positive and negative transitions is independent.

Concerning the threshold operation on the positive transitions: the transistor T5 is biased at its base by a control voltage SC1 from a divider bridge constituted by resistances R8 and R9, i.e. by a fraction of the control signal 110 with which the threshold value of the positive transitions can be varied. The transistor T5 also receives the derivative signal 105 via the coupling capacitor C3. If said voltage SC1 is a quantity Δ1 less than the threshold voltage Vbe of the base-emitter junction of transistor T5, the transistor T5 will only be turned on during positive transmissions having a value of more than Δ1. In other words, the threshold value corresponds to the quantity Δ1 and the output of the transistor T5 only supplies the positive transitions which are higher than said threshold value.

Concerning the threshold operation on the negative transitions: the transistor T3 is biased at its base by a control voltage SC2 from the divider bridge constituted by resistances R4 and R5, i.e. by a fraction of the control signal 111 with which the threshold value of the negative transitions can be varied. The transistor T3 also receives the derivative signal 105 via the coupling capacitor C2. If said voltage SC2 is a quantity Δ2 higher than the value (VCC-Vbe), in which VCC is the power supply value and Vbe is the threshold value of the base-emitter junction of the transistor T3, the transistor T3 will only be turned on during negative transitions having a value of less than −Δ2. In other words, the threshold value corresponds to the quantity −Δ2 and the output of the transistor T3 only supplies the negative transitions of the level which is lower than said threshold.

It should be noted that each voltage divider bridge may be replaced by a direct voltage drive by means of a control signal having an adequate amplitude. However, the use of voltage divider bridges allows working with a control signal having a larger amplitude which is generated by the converter, which facilitates the choice of the converter of the D/A type, the majority of which is dedicated to the generation of values of a large amplitude.

The clipping circuit 115 allows clipping of said output signal 108 conveying the modified positive transitions by means of the transistor T6, and the clipping of said second output signal 107 conveying the modified negative transitions by means of the transistor T4. The clipping level of the positive transitions and the clipping level of the negative transitions are regulated via the set of resistances R6-R7-R10-R11 which allow the saturation and blocking threshold of the transistors T4 and T6 to be varied. Via a unit gain amplification by the transistor T7, the output of the clipping circuit 115 supplies a modified derivative signal 116 conveying the positive and negative transitions.

If no clipping is desired, the base-emitter junctions of the transistors T4 and T6 are short-circuited.

The modified and clipped derivative signal 116 is amplified by the amplifier circuit 117. This circuit is based on the use of two complementary transistors T8 and T9 whose collectors supply the amplified output signal applied to the coil 118 and the capacitance C4.

The computation means 112 analyze the video signal 103 for extracting characteristic parameters 113. These computation means are preferably of the signal processor type so as to be able to perform analyses or computations of a different nature on one and the same processing unit.

The noise level of the video signal is particularly estimated by means of methods known to those skilled in the art, for example, filtering methods. The spectral distribution of the video signal may also be computed to identify the frequency ranges that are covered by the noise signal and will not have to be subjected to an accentuation. More simply, by analyzing the coding type of the video signal, the computation means may identify the video signal type among, for example, the PAL-SECAM-RGB-NTSC types.

The computation means 112 preferably update the characteristic parameters of the video signal 103 periodically with a period which is longer than that of the image period. Indeed, this prevents modification of the image contrast several times per image, which would be visually fatiguing for a user.

The conversion means 114 allow supply of the double control signal 109 composed of the control signal 110 and the control signal 111. They allow variation of the level of the control signals 110-111 as a function of the value of the parameters 113. For example, the level of the control signals SC1-SC2, i.e. the control signals 110-111 may be proportional to the noise level measured in the video signal 103, or may take a value which is different for each type of video signal.

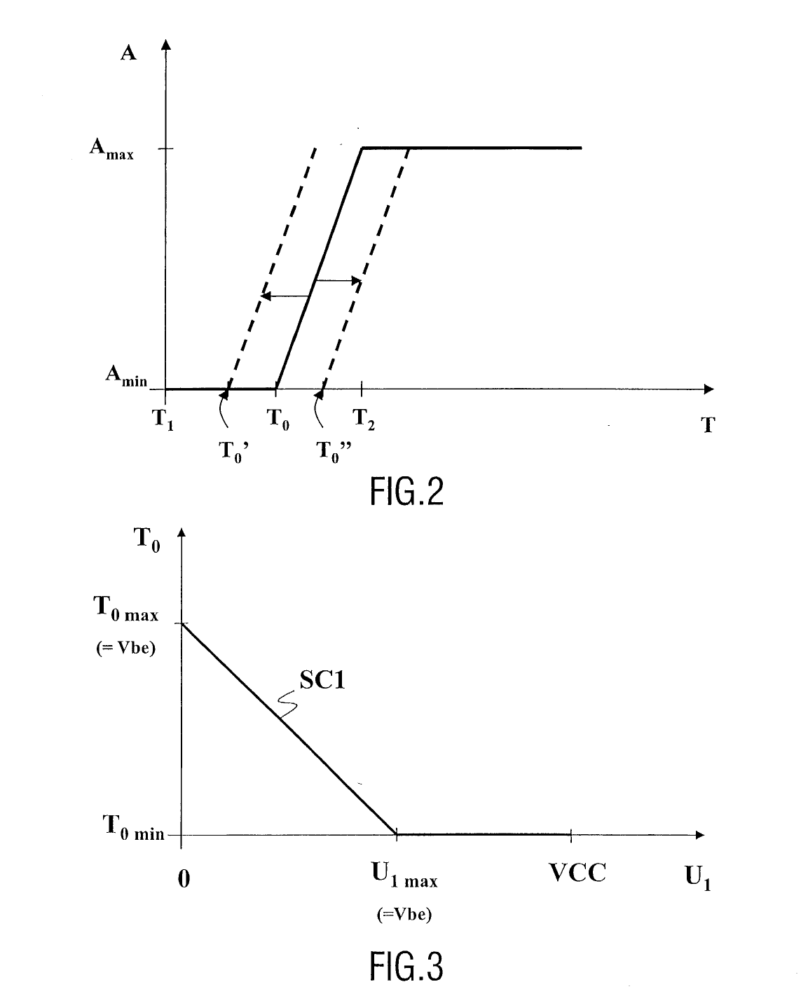

FIG. 2 shows the variation of the level of accentuation A of transitions of the video signal as a function of the transition level T (in absolute value) of said video signal. This Figure perfectly illustrates the characteristic feature of the invention with which the threshold value T₀ above which the transitions are not accentuated can be varied. The variation of the threshold T₀ is illustrated in this Figure for two threshold values T₀′ and T₀″.

A first range [T₁,T₀] defines a zone in which the transitions of a low level are not accentuated because they are generated by the noise signal. In other words, the threshold zone is concerned where the transitions are forced at a value of Aₘᵢₙ=0.

A second range [T₀,T₂] defines a zone in which the transitions are accentuated, for example, in a manner proportional to their level. Indeed, the value of the threshold T₀ is automatically adjusted in such a way that the transitions are accentuated for the transitions generated by the information signal. The accentuation slope may thus be steeper as the threshold T₀ is precisely known, which allows having a strong accentuation on all the transitions of the information signal.

A third range [T₂, . . . ] defines a zone in which the transitions are accentuated in the same manner. In other words, the clipping zone is concerned where the transitions are fixed at the value Aₘₐₓ.

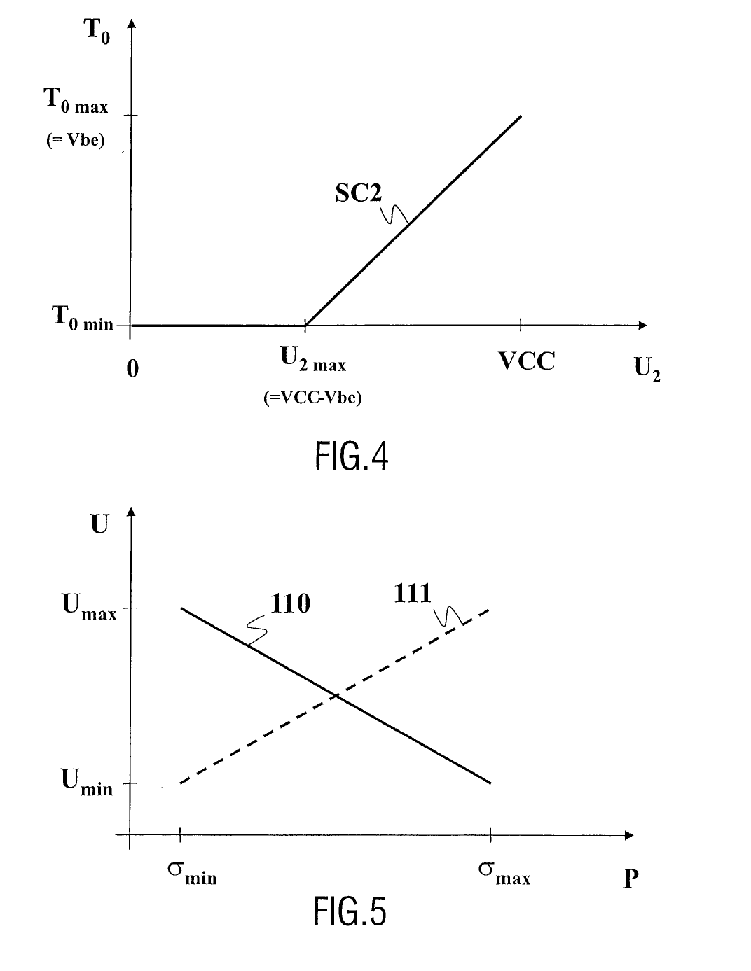

FIGS. 3 and 4 show the variation of the threshold value T₀ (in absolute value) as a function of the levels U₁ and U₂ of the signals SC1 and SC2, respectively. As described in FIG. 1, the signals SC1 and SC2 are supplied by the voltage divider bridges constituted by R4-R5 and R8-R9 and their level corresponds to a fraction of the level of the control signals 110 and 111, respectively.

FIG. 3 shows two distinct ranges of varying the threshold value T₀:

a first range [0,U₁ₘₐₓ] defines a zone in which the threshold value T₀ decreases linearly when the voltage U₁ increases, which means that the positive transitions of a low level in the derivative signal 105 are less and less attenuated by the threshold operation. For example, a video signal to be displayed, comprising a non-zero noise signal is concerned,

a second range [U₁ₘₐₓ,VCC] defines a zone in which the threshold value T₀ remains at a constant minimum level T₀ₘᵢₙ when the voltage U₁ increases, which means that no positive transition in the derivative signal 105 is attenuated by the threshold operation. If T₀ₘᵢₙ=0, for example, a video signal to be displayed, comprising no noise signals is concerned.

Similarly, FIG. 4 shows two distinct ranges of varying the threshold value T₀:

a first range [O, U₂ₘₐₓ] defines a zone in which the threshold value T₀ remains at a constant minimum level T₀ₘᵢₙ when the voltage U₂ increases, which means that no negative transition in the derivative signal 105 is attenuated by the threshold operation. If T₀ₘᵢₙ=0, for example, a video signal to be displayed, comprising no noise signal is concerned,

a second range [U₂ₘₐₓ,VCC] defines a zone in which the threshold value T₀ increases linearly when the voltage U₂ increases, which means that the negative transitions of a low level in the derivative signal 105 are more and more attenuated by the threshold operation. For example, a video signal to be displayed, comprising a non-zero noise signal is concerned.

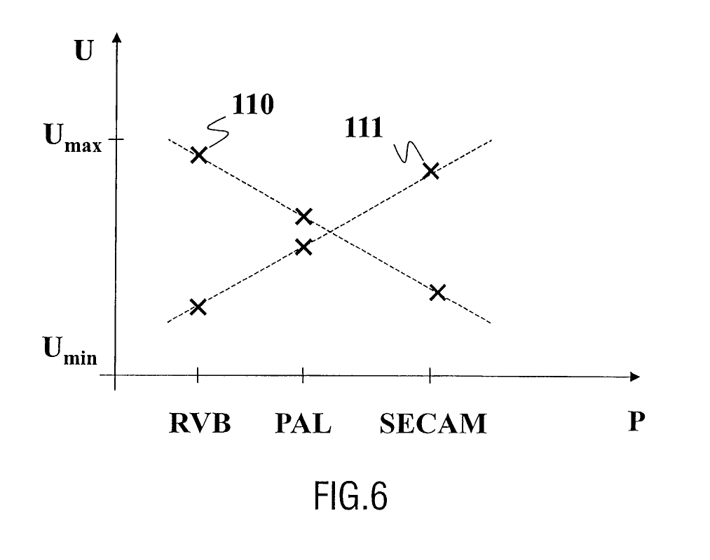

FIGS. 5 and 6 show, by way of non-limiting example, the development of the control signals 110 and 111 as a function of the value of the parameters P characterizing the video signal 103 to be displayed, the signals 110 and 111 being generated by the conversion means 114.

FIG. 5 shows a continuous linear development of the control signals 110 and 111 as a function of the noise level σ taken as a characteristic parameter of the video signal 103 to be displayed. At each noise level σ measured by the computation means 112, an output level U is thus defined for the signals 110 and 111.

FIG. 6 shows a discrete linear development of the control signals 110 and 111 as a function of the format of the video signal 103 taken as a parameter. An output level U for the signals 110 and 111 is thus defined at each format of the video signal identified by the computation means 112, with which a value is associated. This supposes an a priori definition of a classification of video formats as a function of, for example, their noise level.

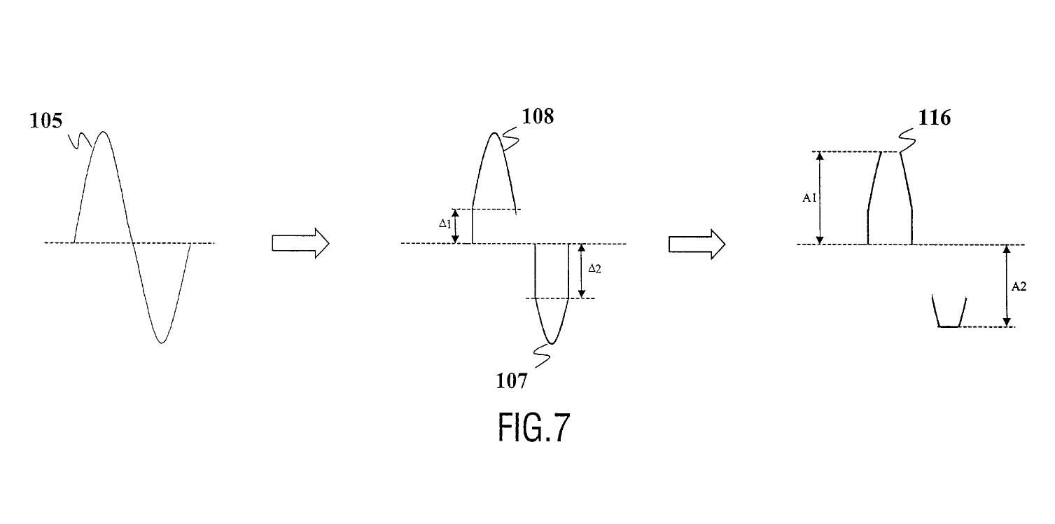

FIG. 7 shows the modification of a derivative signal 105 by the threshold circuit 106 and a clipping circuit 115 according to the invention.

This Figure illustrates the threshold operation performed on the positive part of the transition in the sense that only the values above the threshold Al are transmitted on this positive part so as to form the modified derivative signal 108. Similarly, this Figure illustrates the threshold operation performed on the negative part of the transition in the sense that only the values below the threshold Δ2 are transmitted on this negative part so as to form the modified derivative signal 107.

Secondly, the signals 108 and 107 are clipped at the value A1 for the positive part of the transition and at the value A2 for the negative part of the transition, respectively, so as to form the clipped modified derivative signal 116.

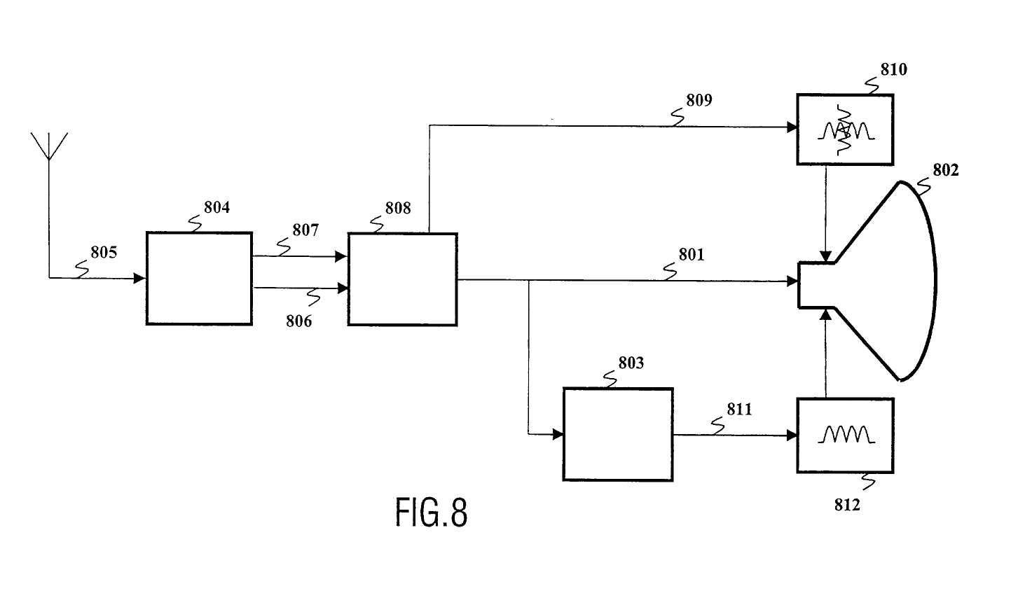

FIG. 8 illustrates a display device for displaying the contents of a video signal 801 on a screen 802 of the cathode ray tube type. This apparatus comprises a device 803 according to the invention for improving the impression of contrast of the displayed video signal. This display apparatus particularly corresponds to a television apparatus.

This apparatus comprises a tuning and demodulation device 804 for tuning and demodulating a RF signal 805. The device 804 supplies a demodulated video signal 806 as well as a set of synchronizing and deflection signals 807. A processing circuit 808 processes and amplifies the signals 807-808 for supplying said video signal 801, on the one hand, and amplified deflection signals 809, on the other hand. The signals 809 are applied to the deflection coils 810 for horizontal and vertical scanning of the electron beams in the tube 802. The signal 801 is a signal of the RGB type applied to the tube 802.

A device 803 according to the invention as described in FIG. 1 and particularly comprising a threshold circuit having a variable threshold receives the video signal 801 at the input and supplies a modified derivative signal 811. The signal 811 is applied to the modulation circuit 812 which comprises an additional deflection coil for modulating the horizontal velocity of said electron beam.

The scope of the invention as described and allowing a variation of the threshold value in the threshold circuit is not limited to the implementation proposed in the diagram of FIG. 1. For example, it is by all means possible to realize the threshold operation at the variable threshold by means of an algorithm whose control codes are stored in a memory and executed by means of a signal processor.

1. A device for displaying a video signal on a screen by means of a scanning operation, said video signal being characterized by an assembly of parameters, said display device comprising:
a derivative circuit for generating a derivative signal from said video signal,
a threshold circuit for performing a threshold operation at a given threshold on said derivative signal so as to generate a modified derivative signal,
a modulation circuit for modulating the scanning velocity on the basis of said modified derivative signal,
characterized in that the display device comprises additional means for varying the value of said threshold as a function of said parameters.

2. A display device as claimed in claim 1, characterized in that said parameters correspond to the noise level of said video signal, to its format or to its spectral power.

3. A display device as claimed in claim 2, characterized in that said additional means comprise:
means for analyzing and extracting said parameters from said video signal,
means for converting said parameters into a control signal for varying the value of said threshold.

4. A display device as claimed in claim 3, characterized in that said analysis means comprise a signal processor and in that said conversion means comprise a D/A converter.

5. A display device as claimed in claim 4, characterized in that said threshold circuit is constituted by two circuits each comprising a transistor arranged in a voltage follower configuration and biased by said control signal.

6. A display device as claimed in claims 1 to 5, characterized in that the device comprises a clipping circuit for clipping said modified derivative signal.

7. A method of displaying a video signal on a screen by means of a scanning operation, said video signal being characterized by an assembly of parameters, the method comprising the steps of:
deriving for generating a derivative signal from said video signal,
performing a threshold operation at a given threshold on said derivative signal so as to generate a modified derivative signal,
modulating the scanning velocity on the basis of said modified derivative signal,
characterized in that the display device comprises an additional step of varying the value of said threshold as a function of said parameters.

8. A television apparatus comprising a screen for displaying a video signal by means of a scanning operation, said video signal being characterized by an assembly of parameters, the television apparatus comprising:
a derivative circuit for generating a derivative signal from said video signal,
a threshold circuit for performing a threshold operation at a given threshold on said derivative signal so as to generate a modified derivative signal,
a modulation circuit for modulating the scanning velocity on the basis of said modified derivative signal,
characterized in that the television apparatus comprises additional means for varying the value of said threshold as a function of said parameters.

9. A television apparatus as claimed in claim 8, characterized in that said parameters correspond to the noise level of said video signal, to its format or to its spectral power.

10. A television apparatus as claimed in claim 9, characterized in that said additional means comprise:
means for analyzing and extracting said parameters from said video signal,
means for converting said parameters into a control signal for varying the value of said threshold.
